(19) United States
(12) Patent Application Publication
(10) Pub. No.: US 2014/0278478 A1
(43) Pub. Date: Sep. 18, 2014

(54) SYSTEMS AND METHODS FOR ANALYTICS-BASED PATIENT MANAGEMENT

(71) Applicant: Guardsman Scientific, Inc., Park City, UT (US)

(72) Inventor: Daniel P. Vezina, Park City, UT (US)

(21) Appl. No.: 13/912,763

(22) Filed: Jun. 7, 2013

Related U.S. Application Data
(60) Provisional application No. 61/780,415, filed on Mar. 13, 2013.

(51) Int. Cl. G06F 19/00

(52) U.S. Cl. CPC G06F 19/345
USPC 705/2

(57) ABSTRACT

Implementations described and claimed herein provide systems and methods for managing one or more patients using non-linear analytics to monitor, respond to, and report patient conditions and/or to develop and optimize interventions or treatments. In one implementation, a clinical management strategy is generated based on cardiovascular function status of one or more patients. Clinical intelligence that is generated based on structured and unstructured data according to an operational mode is received, and the clinical management strategy is optimized based on the clinical intelligence.

### CROSS-REFERENCE TO RELATED APPLICATIONS

The present application claims priority under 35 U.S.C. §119 to U.S. provisional patent application 61/780,415, which was filed Mar. 13, 2013, entitled “System and Method for Analytics-Based Patient Management,” and is hereby incorporated by reference in its entirety into the present application.

### TECHNICAL FIELD

Aspects of the present disclosure relate to patient management and more particularly to clinical data acquisition, collection, transmission, and analysis for monitoring, responding to, and reporting on patient conditions. In some aspects of the present disclosure, the patient conditions relate to circulatory function or hemodynamic status.

### BACKGROUND

Proper circulatory function is essential to sustain and prolong life. From a more practical standpoint, circulatory function can be a factor affecting health care costs resulting from complications, hospital readmissions, and mortality. According to some professionals, ensuring the adequacy of circulatory function is one of the most important clinical goals of healthcare providers when managing the well-being and clinical performance of patients. Many professional medical societies endorse the use of the EKG monitor, systemic blood pressure (BP), pulse oximetry (SpO2), and urine output (UO), known as conventional parameters, as the standard of care of assessing and managing a patient circulatory function.

Using the conventional parameters may be clinically acceptable for patients with normal cardiovascular function. However, the conventional parameters often provide incomplete information for patients with cardiovascular risk factors and/or comorbidities. For example, in various clinical settings, managing the circulatory function of a patient with diastolic dysfunction and or systolic dysfunction, also known as congestive heart failure (CHF) using only the conventional parameters and commonly used clinical strategies can lead a practitioner to deliver inappropriate pharmacologic and non-pharmacologic therapies, leading to volume overload of the circulatory system of the patient. As a result of the incomplete information, many patients may be at risk of not receiving optimal hemodynamic management. This can lead to cardiovascular complications, major organ failure, hospital admission or readmission, and/or death. This result is both detrimental to the health of the patient and costly to the health care system.

This weakness in the current standard of care using the conventional parameters is compounded by the fact that CHF, is the leading admission diagnosis for medicine and cardiology services in the United States. Further adding to the problem is that diastolic dysfunction, often the underlying cause of CHF, is common among the baby boomer population. For individuals over 65, 53.8% suffer from some degree of diastolic dysfunction (40.7% mild and 13.1% moderate or severe). The number of individuals over 65 has been projected to increase by 50% from 2000 to 2020, and as a result, the baby boomer population is recognized as a driving force for healthcare services.

Conventional circulatory function parameters may provide incomplete information for patients with cardiovascular risk factors and/or comorbidities. CHF is an example of one of those conditions and is also a common condition among the baby boomer population and the population as a whole. The health related and economic costs associated with complications, admission, readmissions, and mortality rates need to be addressed. Accordingly, there is a need for a more capable method and system for analyzing and managing the hemodynamics of patients.

It is with these observations in mind, among others, that various aspects of the present disclosure were conceived and developed.

### SUMMARY

Implementations described and claimed herein provide systems and methods for managing one or more patients using non-linear analytics to monitor, respond to, and report patient conditions and/or to optimize interventions or treatments. In one implementation, a clinical management strategy is generated based on a clinical parameter status, such as a cardiovascular function status, of one or more patients. Clinical intelligence that is generated based on structured and unstructured data according to an operational mode is received, and the clinical management strategy is optimized based on the clinical intelligence.

In another implementation, a query relating to clinical patient management is received. A subset of structured and unstructured data is received from one or more storage cluster locations based on a set of connections between one or more relevancy values assigned to the structured and unstructured data. The set of connections correspond to the query. Clinical intelligence responsive to the query is generated based on the subset of structured and unstructured data.

In yet another implementation, structured and unstructured data corresponding to one or more patients is received. One or more relevancy values are assigned to the structured and unstructured data. The relevancy values identify information contained in the structured and unstructured data. The structured and unstructured data are stored based on the assigned relevancy values in one or more storage cluster locations.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example system for analytics-based hemodynamic management of a patient.

FIGS. 2-3 are each front views of an example display used in accordance with the presently disclosed technology.

FIG. 4 is a schematic view of an example controller used in accordance with the presently disclosed technology.

FIG. 5 is a chart showing example categories for statuses of several cardiovascular determinants.

FIG. 6 illustrates an example analytics system for hemodynamic management based on acquired structured and unstructured data sources.

FIGS. 7-18 each show example operations reflecting clinical management strategy processes.

FIG. 19 illustrates example operations for obtaining patient information.

FIG. 20 shows example operations for managing a patient.

FIG. 21 depicts an example network environment that may implement various systems and methods of the presently disclosed technology.

FIG. 22 shows an example computing system that may implement various systems and methods of the presently disclosed technology.

### DETAILED DESCRIPTION

Aspects of the present disclosure involve systems and methods for managing a patient using non-linear analytics to monitor, respond to, and report patient conditions and/or to determine and adjust interventions or treatments.

In one particular aspect, a system for managing a patient includes a patient interface, a provider interface, a controller, and an analytics system. In one implementation, the patient interface is adapted to obtain ultrasound information about the patient, and the provider interface is adapted to receive user input, including queries, from a provider. The controller is in communication with the patient interface and the provider interface. In one implementation, the controller includes a clinical management module adapted to receive the ultrasound information and recommend a clinical management strategy based upon the ultrasound information. The controller is in communication with the analytics system, which processes and stores structured and unstructured data. The analytics system may include analytics capabilities, such as machine learning, to provide clinical medical intelligence regarding best practices, therapies, and clinical interventions based on the structured and unstructured data. The clinical intelligence may be used for point-of-care research purposes.

In another aspect, the systems and methods disclosed herein provide an optimized clinical management strategy for one or more patients. In one implementation, information regarding a condition of a patient is obtained from a probe positioned on the patient. A determinant reflecting the condition of the patient is developed with the controller. A clinical management strategy based on the determinant is generated. The clinical management strategy is optimized based on clinical intelligence generated by the analytics system using structured and unstructured data.

The various systems and methods disclosed herein provide for managing one or more patients using non-linear analytics. The example implementations discussed herein reference circulatory function or hemodynamic status of one or more patients. However, it will be appreciated by those skilled in the art that the presently disclosed technology is applicable to clinical parameter statuses as well as other patient conditions and data.

For a detailed description of analytics-based hemodynamic management of one or more patients, reference is made to FIG. 1. As can be understood from FIG. 1, a hemodynamic management system 100 optimizes clinical intelligence using structured and unstructured data, including circulatory function information. The system 100 and related operations may be similar to the systems and methods disclosed in: U.S. patent application Ser. No. 12/536,247, now U.S. Pat. No. 8,348,847 to Vezina, entitled “System and Method for Managing a Patient” and filed on Aug. 5, 2009; U.S. application Ser. No. 13/179,748, entilted “System and Method for Managing a Patient” and filed on Jul. 11, 2011; and U.S. application Ser. No. 12/646,617, entitled “Peripheral Ultrasound Device” and filed on Dec. 23, 2009. Each of these applications is hereby incorporated by reference in its entirety into this Detailed Description.

In some implementations, the system 100 is an ultrasound-based system configured to provide non-invasive monitoring of circulatory function, including, without limitation, cardiac output and filling pressures. The system 100 utilizes clinical intelligence to provide live monitoring of patients, including humans or animals, undergoing medical procedures or care in a variety of clinical settings, such as anesthesia, surgery, perioperative care, critical care, emergency care, dialysis, or other inpatient or outpatient management care. Further, the system 100 may be used for acute and/or chronic clinical care.

As detailed herein, the system 100 generates and optimizes clinical intelligence based on hemodynamic management data corresponding to one or more patients. Stated differently, the system 100 provides a clinical management strategy for one or more patients in a variety of clinical settings, as well as an ongoing or ad-hoc analysis of the of the clinical management strategy. In one implementation, the hemodynamic management data contains relevant structured and unstructured data, from which circulatory function information may be obtained. Access to this information enables the active management of a patient's circulatory function while the patient undergoes a medical procedure or clinical care and/or permits the formulation of predictive clinical management suggestions for the patient after active care is complete. Additionally, the clinical intelligence may be used for a variety of other purposes, including, but not limited to, policy making, risk assessment and management, best practices determination, and other administrative or medical purposes.

Turning to FIG. 1, in one implementation, the system 100 includes a controller 102, a patient interface 104, and a provider interface 106 in communication with an analytics system 108. The various components of the system 100 may be connected in a variety of manners, for example, directly or via a network 110 (e.g., the Internet).

In one implementation, the network 110 is used by one or more computing and data storage devices (e.g., one or more databases) for implementing the system 100. A user, such as, a patient, provider, or other authorized personnel may access and interact with the analytics system 108 or other components of the system 100 using a user device communicatively coupled to the network 110. The user device is generally any form of computing device capable of interacting with the network 110, such as a personal computer, terminal, mobile device, cell phone, tablet (e.g., iPad), or the like. The controller 102 may include a network interface 114 for facilitating communication with the analytics system 108 via the network 110.

In one implementation, the network 110 includes a server hosting a website or an application that the user may visit to access the analytics system 108. The server may be a single server, a plurality of servers with each server being a physical server or a virtual machine, or a collection of both physical servers and virtual machines. In another implementation, a cloud hosts one or more components of the system 100. The user devices, the server, and other resources connected to the network 110 may access one or more other servers to access one or more websites, applications, web services interfaces, storage devices, computing devices, and the like. The server may also host a search engine that the analytics system 108 uses for accessing, searching for, and modifying hemodynamic management data and other stored data.

Referring to FIG. 1, in one implementation, the controller 102 accesses hemodynamic information relating to one or more patients using the patient interface 104. The provider interface 106 is configured to facilitate the operations of and to receive information output from the controller 102.

In one implementation, the patient interface 104 includes one or more probes 112 adapted to be positioned on a patient to obtain information, such as circulatory information. The probes 112 may be in the form of a transducer adapted to alternate between sending and receiving signals. For example, the probes 112 may be ultrasonic transducers adapted to intermittently or continuously produce and detect ultrasonic waves. However, one or more of the probes 112 may include pressure, flow, impedance, conduction, electrical, or temperature sensors in lieu of or in addition to ultrasonic transducers.

As can be understood from FIG. 1, in one implementation, the probes 112 are positioned on a patient to collect information relating to a hemodynamic status of the patient. The probes 112 may be placed in one of several available windows to gather information about the patient's heart. A window, which may be external or internal to the patient's body, is probe location from where the heart may be imaged using, for example, ultrasound-based imaging technology.

For example, four external cardiac probes 112A-D may be positioned in a transthoracic parasternal window, a transthoracic apical window, a sub-costal window, and a suprasternal notch window, respectively. Further, an internal cardiac probe 112E may be posited in a mid-esophageal window, midway down the esophagus of the patient. An additional probe 112F, such as an external non-cardiac probe, may be adapted to image superficial non-cardiac structures outside the chest of the patient. The probes 112 may include additional or fewer probes of a variety of types or styles, depending on the needs of the patient.

In one implementation, the controller 102 includes an auxiliary device interface 116 configured to interface with one or more auxiliary devices 118 to obtain information relating to a clinical parameter status, such as a hemodynamic or cardiovascular function status, of the patient. The auxiliary devices 118 may include, without limitation, an EKG, a blood pressure monitor, and the like.

As described herein, based on the hemodynamic data obtained from the patient interface 104 and/or the auxiliary devices 118, the analytics system 108 generates and optimizes clinical intelligence. The clinical intelligence may include for example, recommended next clinical interventions of a clinical management strategy. The clinical intelligence may be output, for example, using a display 120 in the provider interface 106 and/or an alternative output 128.

For example, in one implementation, the controller 102 captures ultrasound data of the heart using the patient interface 102. The captured data is compared to a library of data stored in or accessible by the controller 102, which determines which of the library data the captured data most closely resembles. A recommended clinical management strategy associated with the library data is generated. The appropriateness of the recommended clinical management strategy is verified and, if appropriate, executed. As structured and unstructured data is generated, captured, or otherwise collected, the analytics system 108 optimizes the clinical management strategy.

In one implementation, the analytics system 108 includes a database 122, one or more processors 124, and an intelligence module 126. The processor 124 is configured to control some or all of the operations of the analytics system 108 and execute instructions stored in the database 122 and/or the intelligence module 126.

The database 122 may include one or more databases or storage devices for storing structured and unstructured data corresponding to one or more patients. Structured data includes information that is collected, stored, and analyzed in a relational structure. Stated differently, structured data is collected and stored in an organized, linear fashion, and when processed, structured data is traversed sequentially such that only one data element is directly reached. Conversely, unstructured data includes non-linear information, wherein each data element is not arranged in a sequential structure and is instead attached to other data elements in a manner reflecting specific relationships, assigned priorities, and/or assigned relevancies.

Structured data may include cardiovascular function information about one or more patients, generated by the controller 102 using the patient interface 104. For example, the structured data may include, without limitation, information relating to cardiac output, filling pressures, contractility, valvular function, pulmonary artery pressures, heart rate, blood pressure, and heart rhythm. It will be appreciated that the structured data may further include other patient data, including, but not limited to, pulse oxymetry, oxygen saturation, patient height and weight, age, sex, ethnicity, urine output, temperature, type and amount of intravenous venous and/or oral fluid administered, amount and type of medication taken by the patient and/or currently administered to the patient, blood loss, dialysis parameters (e.g., time and amount of ultra filtration fluid), blood chemistry, brain monitoring parameters (e.g., bispectral index and or intracranial pressures), amount of calorie intake and expenditure, respiratory parameters (e.g., end-tidal CO2 levels, amount of oxygen administered, respiratory rate, airway pressures, tidal volumes, ventilatory mode, and/or modality), length of stay in hospital, diagnostic codes (ICD), and procedural codes (CPT).

On the other hand, unstructured data may include care delivery information relating to one or more patients, including text, time, timeline, events, audio feed and/or video feed related to the care delivery provided to the one or more patients. For example, unstructured data may include information relating to a patient's general condition or well-being, symptoms, physical signs, complaints, mood disposition, physical activity, and/or reported food intake and elimination schedule. Further, the unstructured data may include information pertaining to results of clinical interventions or care delivery, such as medical imaging modality (e.g., chest x-ray), perioperative surgical processes (e.g., induction of anesthesia, catheter insertion, skin preparation and draping, incision, retraction, hemostasis, bleeding, dissection, resection, closure, emergence of anesthesia, transportation for postoperative care, progress notes, clinic notes, history and physical hospital admission notes, discharge summary, phone conversations, telemedicine audio and/or video clinical visits), and/or needs and timing for hospital admissions/readmissions after discharge.

In one implementation, the structured and unstructured data is generated, captured, or otherwise collected using the patient interface 104, input by one or more providers via the provider interface 106, input by one or more patients using a user device, extracted from medical health records, and/or other medical sources, such as textbooks or peer-reviewed journal articles. However, other data sources are contemplated.

The analytics system 108 receives data corresponding to one or more patients. In one implementation, as the data is parsed and stored in the database 122, the intelligence module 126 assigns one or more relevancy values identifying information contained in the data. In another implementation, the analytics system 108 assigns one or more relevancy values identifying information contained in the data. The relevancy values may be assigned based on input from a user and/or using machine learning operations, as described herein.

The intelligence module 126 outputs optimized clinical intelligence for the one or more patients based on an analysis of the data. In one implementation, the intelligence module 126 analyzes the data based on the one or more assigned relevancy values and a query, such as user input.

For example, to identify a clinical management strategy for one or more patients, a provider may utilize the system 100 to determine an afterload reduction intervention most commonly used for a patient with a pseudonormal filling pattern. To obtain this information, the provider may input a query, such as all afterload reduction information for hemodynamic management, using the provider interface 106. The intelligence module 126 employs data mining algorithms, such as Parallel Frequent Pattern Mining or Apriori Algorithm, to find a set of terms or itemsets that appear frequently in the data. The frequency may be a predetermined minimum cutoff for exclusion of values that are irrelevant. From this, the intelligence module 126 generates strong association rules based on top frequent itemsets and utilizes collocation techniques to provide a likelihood of relative usefulness. Based on this information, statistical significance, and/or correlation analysis, the intelligence module 126 outputs a list of reduction range of blood pressure to the provider interface 106, from which an afterload reduction intervention most commonly used for a patient with a pseudonormal filling pattern may be determined.

As another example, to determine whether to execute a recommended clinical management strategy for diastolic heart failure for one or more patients, a provider may utilize the system 100 to identify, for a given specialty, which physicians are following the recommended clinical management strategy. To obtain this information, the provider may input a query, such as the specialty of the attending physicians, the intervention executed, and the intervention suggested in the recommended clinical management strategy. Using a clustering algorithm, such as K-Means or Canopy Clustering, the intelligence module 126 outputs a clustering of physicians following the recommended clinical management strategy and a clustering of physicians not following the recommended clinical management strategy.

As yet another example, to identify a clinical management strategy for one or more patients, a provider may utilize the system 100 to determine intervention(s) favored most strongly for New York Heart Association Class 4 heart failure. To obtain this information, the provider may input a query, such as hemodynamic data captured for one or more patients. Using techniques, such as Opinion Mining or Sentiment Analysis, the intelligence module 126 identifies product (intervention) features and opinions about the product features, determines a polarity of the opinions, and ranks the opinions based on the polarity. Based on this analysis, the intelligence module 126 outputs a list of intervention(s) that were strongly preferred by class, ranked by preference.

Accordingly, in one implementation, the system 100 provides prospective or retrospective static or dynamic analytics for one or more patients. Prospective static analytics refers to an intelligence process that analyzes data after completion of clinical events to modify or otherwise optimize future clinical management strategies. Prospective dynamic analytics refers to an intelligence process that analyzes data in real-time to provide an on-going assessment, adjustment and/or modification of recommended clinical management strategies for future clinical events. For example, the system 100 may provide prospective dynamic analytics in the form of a modified clinical management strategy having a recommended next intervention. Conversely, retrospective analytics refers to an intelligence process that analyzes data after completion of clinical events to provide clinical intelligence related to the efficacy, potential outcomes, and/or cost-effectiveness of one or more interventions conducted on the one or more patients.

In one implementation, the system 100 generates point-of-care (POC) research, which involves the collection and analysis of relevant clinical data and interventions performed on one or more patients as part of the care delivery. Stated differently, POC research uses structured and unstructured data resulting from clinical care delivery in a structured research analytics process. POC research may be used to develop and/or optimize a clinical management strategy for a patient or a group of patients sharing some clinical similarities. In generating POC research, the analytics system 108 analyzes and correlates the clinical data with other data sources prospectively or retrospectively. In contrast to research that submits a patient to a specific studied intervention (e.g., double-blinded prospective research), POC research analyzes clinical events, data, and inventions relating to a patient while the patient is undergoing care delivery. In one implementation, such information is captured, generated, or otherwise collected using the controller 102, the patient interface 104, and/or the provider interface 106.

The analytics system 108 may provide the clinical intelligence in substantially real-time as the delivery of care in ongoing to the one or more patients or after an intervention is executed or care delivered. In one implementation, the clinical intelligence is output to the provider interface 106 and presented on the display 120.

In another implementation, the clinical intelligence is presented to providers, researchers, administrators, or other authorized users using the alternative output 128. Further, such authorized users may use an alternative input and query system 130 to access the analytics system 108. In some implementations, the alternative input and query system 130 is connected to the analytics system 108 via the network 110. The alternative inputs and query system 130 may be any computing device, including, without limitation, an admission database/system, a billing database/system, an electronic health patient record system, or the like.

In one implementation, the clinical intelligence is used to develop or optimize a recommended clinical management strategy, including, for example, a suggested next intervention for execution after the completion of current clinical events. In another implementation, the clinical intelligence is data relating to potential outcome of one or many clinical management strategies, such as length of stay, complications, readmissons, mortality, and costs. As such, the clinical intelligence generated by the analytics system 108 improves clinical management, which translates into better clinical outcomes, such as reduction of costs, length of patient stay, and readmission to hospital after discharge, as well as prevention of admission for outpatients and even reduction of mortality.

Turning to FIGS. 2-3, front views of the provider interface 106 are shown. In one implementation, the provider interface 106 includes one or more provider input devices and one or more provider output devices. The provider input devices may include, for example, a keyboard, mouse, joystick, touchpad, and microphone. However, other provider input devices, such as a patient health record in electronic format, or other computing devices or content are contemplated. The provider output devices may include, for example, the display 120, a printer, a speaker, or the like.

In one implementation, the display 120 is a cathode-ray tube (CRT), a liquid crystal display (LCD), a plasma based display, or the like. The display 120 may be large enough to present clear ultrasound images and image acquisition sequencing. For example, the display 120 may be adapted to present four digital loops at the same time as shown in FIGS. 2-3. However, additional or fewer loops may be provided. The display 120 may also be adapted for displaying an EKG signal or a blood pressure value. In one implementation, the display 120 displays a value for continuous left-sided cardiac output. For example, the display 120 may read 5 Liters/min. Additionally, consideration can be given to the workspace of the provider and as such, the display 120 can be similar in size to a monitor display on an EKG or a blood pressure monitor. In some implementations, the display 120 functions as an output device and an input device via a touch screen for receiving input information from the provider and displaying information, such as clinical intelligence. Alternatively or additionally, the display 120 may include buttons or switches as shown in FIGS. 2-3. In one implementation, data is shown on the display 120 according to instructions issued by the controller 102.

For a detailed description of the controller 102, reference is made to FIG. 4. The controller 102 may be any form computing device capable of interacting with the various components of the system 100. In one implementation, the controller 102 is a field programmable gate array, a mixed signal micro controller, an integrated circuit, a printed circuit board, a virtual machine, or the like.

The controller 102 is adapted to communicate with and control one or more interfaces. For example, the controller 102 may be configured to control the auxiliary devices 118 via the auxiliary device interface 116, which may include one or more ports for connection to the auxiliary devices 118. The ports may be, for example, a plug-type socket on the controller 102 for receiving a lead from the auxiliary devices 118. In one implementation, the auxiliary device interface 116 is a wireless based interface for exchanging information with the auxiliary devices 118.

Further, the controller 102 may be configured to exchange data over the network 110 via the network interface 114, which may include one or more jacks. The jacks may be, for example, a connection socket on the controller 102 for receiving a network cable, such as an Ethernet connection jack, USB port, or phone jack. In one implementation, the network interface 114 is a wireless based interface for communicating with the various components of the system 100 via the network 110.

In one implementation, the controller 102 includes a patient interface module 132, an analysis module 134, and a provider interface module 136. The provider interface module 136 may further include a clinical management module 138, an electronic reporting module 140, and a Diagnosis Related Group (DRG) reporting module 142. Other modules adapted for receiving, sending, interpreting, or analyzing data and any combination of processes can also be included in any given module.

The patient interface module 132 is adapted to communicate with and control the patient interface 104. In one implementation, the patient interface module 132 is adapted to drive the probes 112, initiate probe signals, and/or receive probe data. For example, in one implementation, the patient interface module 132 includes an image generating module 144 configured to capture one or more images from the probes 112.

As discussed herein, the probes 112 may include ultrasonic transducers. Accordingly, the image generating module 144, in one implementation, is configured to control ultrasonic transducers to generate, transmit, and receive ultrasonic waves. As such, the image generating module 144 performs beamforming, array beamforming, and signal processing functions. The image generating module 144 may produce, for example, two-dimensional and three-dimensional imaging as well as B-mode, M-mode, color Doppler, and spectral Doppler data points.

In one implementation, the patient interface module 132 controls the adjustment of the probe view. Stated differently, where one or more of the probes 112 is adjustable relative to its position on the patient, the patient interface module 132 controls actuation devices for rotating, pivoting, translating, or otherwise adjusting the position and view obtained by the probe 112. In another implementation, the adjustment of the probes 112 is manually performed with knobs or other physical adjustment devices.

The patient interface module 132 is adapted to periodically or continuously collect data via the probes 112 of the patient interface 104. In one implementation, the patient interface module 132 automatically acquires ultrasound-generated data points at a selected time interval. For example, the patient interface module 132 may obtain cardiovascular information about a patient every minute, every two minutes, every 10 minutes, or at any time interval selected by a provider or other user. In another implementation, the patient interface module 132 acquires data upon manual command.

Further, in one implementation, the patient interface module 132 controls the manner in which the probes 112 collect data. In other words, the patient interface module 132 selects a mode from one or more modes for any of the probes 112 to capture the data. The modes may be shown on the display 120 in a video loop format. One or more of the modes of data collection may include, for example, a) 2D or 3D black and white images b) Color Doppler images, and c) Spectral Doppler tracings. The Spectral Doppler tracings mode measures and displays a velocity of blood flow and thus, enables calculation of clinically useful volumes, flows, and pressures based on the measured velocities.

After imaging and acquisition, probe-generated data (e.g., ultrasound-generated data) may be recorded and stored in memory in the controller 102 and/or transmitted to the analysis system 108. In one implementation, the analysis module 134 processes the probe-generated data. The analysis module 134 compares the acquired probe-generated data to a library of stored data, which may be stored in the memory of the controller 102 and/or the database 122 of the analytics system 108. Based on the probe-generated data and/or data provided by the analytics system 108, a determination of the assessment of ventricular contractility, valvular structure and function, cardiac output and filling pressures may be made.

The analysis module 134 may be configured to process information generated from a specific type of probe or to process information generated from various types of probes. For example, in one implementation, the analysis module 134 is configured to process data generated by ultrasonic transducer probes. As such, the analysis module 134 includes one or more algorithms configured to analyze circulatory function information obtained by the transducers and to develop cardiovascular determinants for monitoring one or more patients. These algorithms may include interpretive processes or more calculated processes depending on the information received and the determinants being developed.

In one implementation, the analysis module 134 develops the determinants based on an analysis of one or more types of probe-generated images and/or calculations based on probe-generated data. The development of the determinant may be a substantially calculated process and/or a substantially interpretive process. For example, determining whether the contractile function is normal requires knowledge of how a normal contracting heart appears. Accordingly, this interpretive process may include comparing a captured image clip to image clips with known values or categorizations. Image recognition software may be employed for comparing the captured clip to a series of stored clips. A correlation algorithm for making the comparison may be based on previously defined visual assessment pattern correlations, where the visual assessment was performed by clinical diagnostic experts in cardiac ultrasound imaging, and the clinically adequate and relevant correlation is made based on an evaluation and computation of a large number of cases and images.

In one implementation, the correlation algorithm is performed, in part, by an image recognition module 146, which analyzes the captured image clip, and by comparing the result to a series of stored image clips in a database in the controller 102 and/or the database 122. As discussed herein, in one implementation, each of the stored image clips in the database is assigned to a category based on previous clinical studies. A rating is given to each comparison of a captured image clip to a respective stored image clip. The captured clip may be compared to all of the stored clips and a category may be assigned to the captured image clip consistent with those image clips to which the comparison had the highest ratings. Alternatively or additionally, a trend of a likeness to a given category of stored clips may be recognized and a category may be assigned accordingly. The captured image clip is categorized consistent with the stored image clip or clips that it most closely resembles. Other algorithms may be followed to correlate a captured image clip with a category of clips in a database and these other algorithms are within the scope of the present disclosure. Based on this correlation or other algorithms or analysis, the analysis module develops one or more determinants.

The determinants may include, without limitation, contractile function, valvular function, cardiac output, and filling pressures. Regarding the contractile function determinant, the analysis module 134 develops right and/or left contractile function information by analyzing a captured 2D and/or 3D image clip, provided by the patient interface 104. The captured image clip is compared to image clips in a contractile function image clip database, and a category is assigned to the captured image clip, for example, as shown in FIG. 5. Accordingly, the correlation algorithm may be used to categorize the acquired image clip into a ventricular contractile function pattern, including hyperdynamic, normal, moderately reduced, or severely reduced.

With respect to the valvular function determinant, the analysis module 134 provides an assessment of the presence and severity of mitral, aortic, and tricuspid valve regurgitation based on an analysis of color Doppler images, captured by the patient interface 104. The analysis module 134 compares the color Doppler image to image clips in respective mitral, aortic, and tricuspid image clip databases and assigns a category to the captured image clip for each valve. Accordingly, the correlation algorithm is used to categorize the valvular function of each valve, for example, as shown in FIG. 5. For the mitral valve, the correlation algorithm may categorize the captured image clip into a mitral regurgitation pattern, such as mild, moderate, or severe. For the aortic valve, the algorithm may categorize the captured image clip into a mild or severe aortic regurgitation pattern. For the tricuspid valve, the algorithm may categorize the captured image clip into a mild or severe tricuspid regurgitation pattern.

Turning to the cardiac output and filling pressures determinants, the analysis module 134 utilizes spectral Doppler tracings, provided by the patient interface 104. For example, the analysis module 134 uses the spectral Doppler tracings to provide a basic assessment of the left ventricular diastolic function, the left ventricular filling pressure, the systolic pulmonary artery pressure, the presence and severity of aortic stenosis, and the cardiac output.

Regarding diastolic function determinant, a spectral Doppler tracing relating to the mitral inflow (i.e., the mitral inflow tracing) can be used to obtain an image clip with the patient interface 104. The captured clip is compared to stored clips in a diastolic dysfunction image clip database and a category is assigned to the captured image clip, for example, as shown in FIG. 5. Accordingly, the captured image clip can be categorized into a mild, moderate, or severe diastolic dysfunction pattern.

With respect to the left ventricular filling pressure determinants, a general filling pressure determinant is developed using a spectral Doppler tracing relating to the pulmonary venous flow. A captured image is obtained of the spectral Doppler tracing using the patient interface 104, a comparison is made to a database of filling pressure image clips, and a category is assigned to the captured clip, for example, as shown in FIG. 5. Accordingly, the captured clip can be categorized into a normal or elevated left ventricle filling pressure pattern. In one implementation, the filling pressure is estimated by calculating a ratio between two spectral Doppler direct measurements. The peak velocity of the E wave of the mitral inflow and of the e′ mitral annulus wave (septal, lateral, and/or average) of the tissue Doppler may be directly measured using spectral Doppler. The ratio of the E wave to the e′ mitral annulus wave provides a numerical estimate of the left ventricular filling pressure. Once calculated, the filling pressure is numerically compared to known normal pressures.

Regarding the systolic pulmonary artery pressure determinants, a spectral Doppler tracing of the velocity of the red cells of the systolic tricuspid regurgitation jet is obtained by the patient interface 104. A direct measurement of the peak velocity may provide a clinically relevant estimation of the systolic pulmonary artery pressure using the simplified Bernoulli equation.

With respect to mitral and aortic stenosis determinants, the patient interface 104 makes direct measurements of spectral Doppler tracings. For mitral stenosis, the mean gradient of pressure may be directly measured from the spectral Doppler tracing of the mitral inflow and the severity of mitral stenosis may thus be defined as mild, moderate, or severe. For aortic stenosis, the peak velocities may be directly measured from the spectral Doppler tracing of the red cells in the left ventricular outflow tract (LVOT) and at the aortic valve. The ratio of the peak velocities of the red cells in the LVOT to those at the aortic valve may define the severity of aortic stenosis as mild if the ratio is 1:2, moderate if the ratio 1:3, or severe if the ratio is 1:4.

Finally, regarding the cardiac output determinant, the patient interface 104 may make two direct measurements. The profile of the spectral Doppler tracing obtained from the LVOT during systole may be used to determine the average distance red cells travel during this event. Stated differently, the area under the spectral Doppler tracing, or the integral of the tracing, may provide this average distance. Additionally, the diameter of the LVOT may be directly measured allowing for the geometric calculation of LVOT area. With those two data points, the average distance of red cell travel and LVOT area, the patient stroke volume and therefore the cardiac output can be calculated using the heart rate times the stroke volume.

In one implementation, the provider interface module 136 executes instructions for outputting information, such as data provided by the patient interface 104 and the analysis module 134, including the developed determinants. The provider interface module 136 is configured to interpret information received from one or more provider input devices, as described herein. For example, the provider interface module 136 may include voice recognition software for interpreting audio input. In one implementation, the provider interface module 136 includes a display module 148, configured to present visual information, including, for example, graphs, images, text, charts, or the like on the display 120, printouts, or other output mechanisms. The display module 148 executes instructions to display a series of menus for selection to produce or retrieve reports, medical record data, billing information, and other output types.

Further, in one implementation, the display module 148 produces image displays of anatomy scanned by the probes 112. In other words, the display module 148 is adapted to show the data obtained from the several modes of operation of the probes 112. For example, the probes 112 may produce ultrasound data and the ultrasound-generated data may be displayed on the display 120 as standard ultrasound images. In one implementation, the 2D cross-section images may be black and white moving clips of the heart beating. The images may be looped video clips giving the end-user the appearance of a continuous heart beating. The color Doppler images may be 2D cross-section images with a region of interest (ROI) color box superimposed on a valvular structure and showing the direction and velocity of the blood flow based on the shade and color displayed. This image may also be a looped video clip showing the heart beating. The spectral Doppler tracings may be still images displaying a graphical representation of the variation of the measured red cells velocities over time, usually one cardiac cycle. In one implementation the 2D images are displayed as 3D images and provide the equivalent information on ventricular contractility and valvular structure and function. The provider interface module 136 may output information, such as data provided by the patient interface 104 and the analysis module 134, in other formats and using other devices.

In one implementation, the clinical management module 138 is configured to receive data from the analysis module 134, the provider interface module 136, and/or the analytics system 108 and generate recommended clinical management strategies. The clinical management strategies may be generated based on a variety of data sources, including data obtained via the controller 102 and knowledge and/or studies regarding suitable clinical management of patients.

For example, the clinical management module 138 may include recommended clinical strategies relating to a particular system of the human body, such as the nervous system, digestive system, or circulatory system. The clinical management module 138 may include recommended clinical strategies relating to particular organs or conditions. Strategies relating to other aspects of patients requiring clinical management can be included and the clinical management module 138 can be directed to one or more of these aspects or other aspects of patient management. In one implementation, the clinical management module 138 is adapted to provide a menu or other selection screen allowing for the focusing of the system 100 for a particular clinical management.

In one implementation, the clinical management module 138 is directed toward managing the delivery of anesthetic agents or hemodynamic status of a patient. In another implementation, the clinical management module 138 is adapted for use while the patient undergoes a surgery (before, during, and/or after) or require critical care medicine. In another implementation, the clinical management module 138 is adpated for use for patients presenting clinical needs for emergency medicine, inpatient medical or surgical care, dialysis therapy or outpatient disease management. Accordingly, the clinical management module 138 may be adapted for use with the analysis module 134 and patient interface 104. In one implementation, the clinical management module 138 can receive ultrasound or other data from the analysis module 136 and provide a suitable clinical management strategy. Alternatively or additionally, the data can be input by the provider or other authorized user via the provider interface 106 and/or the alternative input and query system 130, for example, upon interpretation of the ultrasound generated images and/or data.

In one implementation, the clinical management module 138 uses the cardiac output and the left ventricular filling pressures as first order data points to manage a patient's hemodynamic status. Additionally, the clinical management module 138 may use the valvular function and the biventricular contractile function as second order data points to manage a patient's hemodynamic status. The clinical management module 138 assesses the primary and/or secondary order data points and recommends a clinical management strategy. In one implementation, the clinical management strategy suggests the adjustment of one or more cardiovascular determinants. In particular, the strategy may suggest the adjustment of cardiovascular control determinants such as the preload, the afterload, the heart rate, and the ventricular contractility. The clinical strategy may be followed by the provider or the provider may choose not to follow the strategy. In one implementation, the clinical management module 138 optimizes the recommended clinical management strategy based on information obtained from the analytics system 108.

For a detailed discussion of the analytics system 108, reference is made to FIG. 6. As can be understood from FIG. 6, the analytics system 108 generates clinical intelligence for hemodynamic management based on acquired structured and unstructured data sources.

In one implementation, data sources 200, including structured and unstructured data, are provided to a storage cluster 202. The data sources 200 include structured and unstructured hemodynamic data 204 for one or more patients, obtained using the system 100. The structured hemodynamic data 204 may be acquired by the patient interface 104 at the direction of the controller 102. In one implementation, the structured hemodynamic data 204 includes cardiovascular information, as described herein. The cardiovascular information includes first order data points (e.g., cardiac output, filling pressure, or similar determinants), second order data points (e.g., contractility, valvular function, or similar determinants), and/or other data points. Other hemodynamic data 204 may include, without limitation, patient blood pressure, heart rate, SpO2, IV fluid amount administered. The unstructured hemodynamic data 204 includes, but is not limited to, care delivery information relating to one or more patients, such as a text, audio and/or video format description of a series of clinical events associated with the care delivery of the one or more patients, for example, progress notes, surgical notes, timelines, time stamp descriptions, and/or the like.

The data sources 200 may further include outside data sources 206. In one implementation, the outside data sources 206 include structured or unstructured data generated by other systems, medical providers, or the patient direct input and may include, for example, content of a patient medical record, scientific textbooks, and/or peer-reviewed journals.

The data sources 200 provided to the storage cluster 202 are stored in one or more non-relational databases 208. The data elements in the data sources 200 may be tagged with one or more relevancy values, which represent information contained in a data element. In one implementation, the relevancy values are assigned a priority. For example, first order data points may be assigned a higher priority than other data points. The relevancy values and the priorities may be assigned as the data is provided or stored in the non-relational database 208.

The storage cluster 202 is configured to parse, tag, and/or associate data elements for storage and analysis. In one implementation, the storage cluster 202 includes a file system 210, a connectivity module 212, an aggregation module 214, a transformation module 216, a query module 218, and a data mining module 220 connected via a bus 230. However, additional or fewer modules or components are contemplated. Moreover, while each of the various modules and components are depicted in FIG. 6 as individual systems, infrastructures, components and/or applications, it is contemplated that all of such individual systems, infrastructures, components and/or applications may be combined in various ways, including being combined into a single or multiple software applications.

The file system 210 is a distributed, scalable storage layer that is configured to store a large volume of structured and unstructured data. In one implementation, the file system 210 replicates and distributes blocks of data through cluster nodes, along with numerous other features and advantages. As such, the file system 210 generally manages the processing, storage, analysis, and retrieval of large volumes of data in the non-relational database 208. The file system 210 may be, for example, a Hadoop Distributed File System (HDFS) and the non-relational database 208 may be, for example, HBase.

The file system 210 parses and loads unstructured and structured data from the data sources 200 into the storage cluster 202. The connectivity module 212 and/or the aggregation module 214 may extract such data and imports the data into the file system 210 for processing. In one implementation, the connectivity module 212 is configured to import data, such as the hemodynamic management data 204, from relational databases into the storage cluster 202. The connectivity module 212 may be configured to permit a user to assign relevancy values and/or priorities to the data, as well as permit the user to specify a target relevant location for storage. The connectivity module 212 may be, for example, Sqoop, which is a connectivity tool adapted for use in the Hadoop environment. In one implementation, the aggregation module 214 is a framework for populating the storage cluster 202 with data from the outside data sources 206. For example, the aggregation module 214 may collect and integrate data from distributed data sources, such as log files, web servers, application servers, and user devices. The aggregation module 214 may be, for example, Flume, which is a tool for ingesting large amounts of distributed data, adapted for use in the Hadoop environment.

In one implementation, the transformation module 216 transforms and aggregates data for storage in the non-relational database 208. Stated differently, the transformation module 216 transforms raw data into tables, such as HBase tables, or other aggregation for storage and analysis in the storage cluster 202. The transformation module 216 may utilize a high-level data flow language, such as Pig, for ingesting and transforming data. In some implementations, the transformations involve extracting text from formatted documents and/or creating and parsing transcripts of audio or video feeds.

In one implementation, in transforming the data, the query module 218 leverages a reduction framework, such as MapReduce, adapted for use in the Hadoop environment. MapReduce utilizes two primary functions: a map function and a reduce function to provide massively parallel data processing capabilities leveraging data locality in the file system 210. The map function divides a query into multiple parts and processes the data at the cluster node level, and the reduce function aggregates the results of the map function to determine the answer to the query.

Based on an analysis of the data elements and user input, as described herein, the storage cluster 202 outputs clinical medical intelligence 222. In one implementation, the clinical intelligence 222 includes reports 224, advanced analytics 226, and POC research 228. The reports 224 include ad-hoc reports, defined reports, and on-demand reporting relating to clinical management suggestions. For example, the clinical management suggestions may include increasing or reducing blood pressure or an amount of fluid to be administered within a specific time frame as patient care is deployed. The advanced analytics 226 includes recommendations relating to a clinical management strategy. For example, the advanced analytics 226 may include a list of specific medications with dosage and length of therapy suggested for the period after the patient leaves the hospital. The POC research 228 may be either static or dynamic and either prospective or retrospective, as described herein. The POC research 228 may include, for example, a mortality rate and/or a cost associated with a specific intervention in a clinical management strategy. For example, the specific intervention may be reducing the blood pressure below a certain level, such as a systolic blood pressure of 90 mmHg. The clinical intelligence 222 is used to develop and/or optimize a recommended clinical management strategy.

In one implementation, the query module 218 processes data in the storage cluster 202 and outputs the reports 224 using tools generating standard reporting format. For example, the query module 218 may utilize Hive, which is a data warehousing infrastructure built on top of Hadoop providing tools to enable ad hoc querying and data aggregation of large data sets. Hive permits users to write a query in structured query language (SQL), which Hive converts to MapReduce. In another implementation, the query module 218 outputs data in a format enabling further management, analysis, and/or merging with other data sources. In such cases, the query module 218 may utilize tools, such as Karmasphere or JasperForge suite, each adapted for use in the Hadoop environment.

In one implementation, the data mining module 220 outputs the advanced analytics 226 utilizing machine learning techniques. Machine learning generally refers to a machine learning through observing data that represents incomplete information about statistical happenings and generalizing such data to rules and/or algorithms that make predictions for future data, trends, and the like. Machine learning typically includes “classification” where machines learn to automatically recognize complex patterns and make intelligent predictions for a class. The data mining module 220 may use a tool, such as Mahout, which is a machine learning library built on top of Hadoop. Mahout uses algorithms to perform clustering, regression testing, and statistic modeling. In one implementation, the data mining module 220 and/or the query module 218 outputs the POC research 228 using general and ad-hoc reporting and/or machine learning techniques.

As discussed herein, the analytics system 108 outputs the clinical intelligence 222 to the controller 102 for developing and/or optimizing recommended clinical management strategies based on acquired structured and unstructured data sources. FIGS. 7-18 each show example operations reflecting clinical management strategy processes.

As can be understood from FIGS. 7-16, the hemodynamic management system 100 includes one or more algorithms to be followed in delivering patient care based on input information. Referring to FIG. 7, in clinical cases where first order data points 300 indicate a low cardiac output 302 and high filling pressure 304, the recommended clinical management strategy includes reducing the preload 306 and reducing the afterload 308. Another recommended clinical management strategy is depicted in FIG. 8, where the first order data points 300 indicate a low cardiac output 302 and filling pressure 304 within normal limits. In this case, the recommended clinical management strategy includes reducing the afterload 308 and maintaining the current preload 306.

Turning to FIG. 9, where the first order data points 300 indicate a low cardiac output 302 and low filling pressure 304, the recommended clinical management strategy may suggest increasing the preload 306. As shown in FIG. 10, the first order data points 300 may indicate a normal cardiac output 302 and high filling pressure 304. Accordingly, the recommended clinical management strategy includes reducing the preload 306 and maintaining the systemic blood pressure if within normal limits. The recommended clinical management strategy may also include reducing the afterload 308 if the systemic blood pressure is high. In FIG. 11, where the first order data points 300 indicate a normal cardiac output 302 and normal filling pressures 304, the recommended clinical management strategy may be to maintain the current preload 306 and afterload 308 conditions.

As shown in FIG. 12, in clinical cases where the first order data points 300 indicate that the cardiac output 302 remains low despite optimal preload 306 and afterload 308 management and the second order data points 310 indicate a reduced contractile function 312, the recommended clinical management strategy may be made to use inotropic support 314.

Referring to FIG. 13, where the second order data points 310 indicate mitral valve regurgitation 316, the recommended clinical management strategy may be to reduce the afterload 308, maintain a faster heart rate 320, and higher preload 306. Where mitral valve stenosis 318 is indicated, the recommended clinical management strategy may be to reduce the preload 306 and maintain a slower heart rate 320. As shown in FIG. 14, where the second order data points 310 indicate aortic valve regurgitation 322, the recommended clinical management strategy includes reducing the afterload 308, maintaining a faster heart rate 320, and higher preload 306. Turning to FIG. 15, in clinical cases where the second order data points 310 indicate aortic valve stenosis 324 with high filling pressures 304, the recommended clinical management strategy may suggest reducing the preload 306 and maintaining a slower heart rate 320. As shown in FIG. 16, where the second order data points 310 indicate aortic valve stenosis with normal filling pressures 324, the recommended clinical management strategy may be to maintain a slower heart rate 320. The recommended clinical management strategy may also include an indication that afterload 308 reduction is safe for this patient.

Referring to FIGS. 17 and 18, example clinical management strategies are shown with additional detail. Moreover, these strategies are shown to interface with a conventional parameter, such as systolic blood pressure 326. With reference to FIG. 17, where the first order data points 300 indicate that the cardiac output 302 is low, the filling pressure 304 may be analyzed to determine which of two branches to follow for determining a clinical management strategy.

Where the filling pressure 304 is high, three additional branches are based upon systolic blood pressure 326 are followed. For a systolic blood pressure (BP) 326 greater than 120 mmHg, the clinical management strategy may suggest reducing the afterload by 15% and limiting intravenous fluid (IV) to a minimum flow to keep the venous access open (KVO). For a systolic BP 326 of 90 to 120 mmHg, the clinical management strategy may suggest reducing the afterload by 10% and limiting the IV preload to KVO. For a systolic BP 326 less than 90 mmHg, the clinical management strategy may suggest limiting the IV preload to KVO and to consider inotropic support.

Where the filling pressure 304 is normal, three additional branches also based on systolic BP 326 are followed. Where systolic BP 326 is greater than 120 mmHg the clinical management strategy may be to reduce the afterload by 15% and maintain basal IV fluid intake. For a systolic BP 326 of 90 to 120 mmHg, the clinical management strategy may suggest to reduce the afterload by 10% and maintain basal IV fluid intake. Where systolic BP 326 is less than 90 mmHg, the clinical management strategy may suggest limiting the afterload reduction. In this case, if the ejection fraction (EF) is greater than 40% the clinical management strategy may suggest that the provider consider an IV bolus of 250 ml. If EF is less than 40%, the clinical management strategy may suggest that the provider consider inotropic support, and if there is no increase or minimal increase in stoke volume (SV), the clinical management strategy may further suggest that the provider consider an IV bolus of 100 ml.

As can be understood from FIG. 18, a clinical management strategy similar to that in FIG. 17 is shown where the cardiac output 302 is low. Here, the clinical management strategy differs from that shown in FIG. 17 in the normal filling pressure 304 branch. Specifically, in the normal filling pressure 304 branch, where the systolic BP 326 is greater than 120 mmHg, the clinical management strategy suggests an afterload reduction of 10% in lieu of 15%. Also, for a systolic BP 326 of 90 to 120 mmHg, the clinical management strategy suggests maintaining the afterload and the basal IV intake levels in lieu of reducing the afterload by 10% with maintained basal IV intake levels.

It will be appreciated that the present disclosure is not limited to the specific percentages of reductions or increases shown and described. The reductions and increases in cardiovascular control determinants are examples and do not reflect an exhaustive list of the available adjustments in the cardiovascular determinants. Additionally, the exemplary strategies shown in FIGS. 7-18 are not exhaustive. For example, FIGS. 17 and 18 are shown based on cardiac output 302, filling pressure 304, and systolic BP 326. However, other clinical management strategies may be included and based on any combination of cardiovascular determinants. The clinical management strategies may be further based on clinical experience and testing shown to bring cardiovascular functions closer to normal ranges. The clinical management strategies may also be optimized based on the clinical intelligence 222 for one or more patients. The clinical management strategies may be optimized in a dynamic mode while the patient is being treated or in a prospective suggestion for future management of one or more patients.

Turning to FIG. 19, example operations 400 for obtaining patient information are shown. As will be appreciated, the operations 400 utilize acquired patient information in managing and reporting on one or more patient's conditions.

In one implementation, an obtaining operation 402 obtains information regarding a hemodynamic condition of a patient. The obtaining operation 402 may utilize a patient interface, including one or more probes, in obtaining the patient information. A developing operation 404 develops a determinant reflecting the hemodynamic condition of the patient from the patient information. A providing operation 406 provides a clinical management strategy based on the determinant. The clinical management strategy may be used for managing the hemodynamic condition of the patient.

A generating operation 408 generates clinical intelligence relating to the clinical management strategy. In one implementation, the generation operation 408 generates the clinical intelligence based on structured and unstructured data. The clinical intelligence may be, for example, prospective static, prospective dynamic, retrospective, or POC research, as described herein. An optimizing operation 410 optimizing the clinical management strategy based on the clinical intelligence. In one implementation, the optimizing operation 410 provides prospective dynamic management in response to ongoing clinical interventions, which optimizes the clinical management strategy on-demand. In another implementation, the optimizing operation 410 provides prospective predictive management to guide the clinical management strategy in the future. In yet another implementation, the optimizing operation 410 provides a retrospective evaluation of the clinical management strategy.

Referring to FIG. 20, example operations 500 for managing one or more patients are shown. In one implementation, an interpreting operation 502 interprets ultrasound data points. The ultrasound data points may be generated by a patient interface having one or more probes. An obtaining operation 504 obtains first order and second order data points from the ultrasound data points.

A generating operation 506 generates a clinical management strategy based on the first order and second order data points. In one implementation the clinical management strategy includes modification of one or more cardiovascular determinants. For example, the modification may include increase, reduce, and maintain, and the cardiovascular determinants may include preload, afterload, and heart rate.

A receiving operation 508 receives clinical intelligence based on structured and unstructured data according to different operational modes. The structured and unstructured data includes the first order and second order data points. The operational modes may include prospective dynamic, prospective predictive, and retrospective management analysis. An optimizing operation 510 optimizes the clinical management strategy based on the clinical intelligence.

FIG. 21 illustrates an example network environment 600 for implementing the various systems and methods, as described herein. As depicted in FIG. 21, a communications network 602 (e.g., the Internet) is used by one or more computing or data storage devices for implementing the systems and methods for managing one or more patients and/or patient data. In one implementation, the hemodynamic management system 100, one or more user devices 604, and/or other network components or computing devices described herein are communicatively connected to the communications network 602. Examples of the user devices 604 include a terminal, personal computer, a smart-phone, a tablet (e.g., iPad), a multimedia console, a gaming console, a Personal Digital Assistant (PDA), a set top box, etc.

A server 606 hosts the system. In one implementation, the server 606 also hosts a website or an application that users may visit to access the system 100. The server 606 may be one single server, a plurality of servers with each such server being a physical server or a virtual machine, or a collection of both physical servers and virtual machines. In another implementation, a cloud hosts one or more components of the system. The system 100, the user devices 604, the server 606, and other resources connected to the communications network 602 may access one or more additional servers for access to one or more websites, applications, web services interfaces, etc. that are used for patient management. In one implementation, the server 606 also hosts a search engine that the system uses for accessing and modifying information, including without limitation, structured and unstructured data.

FIG. 22 illustrates an example computer system 700 that may be useful in implementing the presently disclosed technology. A general purpose computer system 700 is capable of executing a computer program product to execute a computer process. Data and program files may be input to the computer system 700, which reads the files and executes the programs therein. Some of the elements of a general purpose computer system 700 are shown in FIG. 22 wherein a processor 702 is shown having an input/output (I/O) section 704, a Central Processing Unit (CPU) 706, and a memory section 708. There may be one or more processors 702, such that the processor 702 of the computer system 700 comprises a single central-processing unit 706, or a plurality of processing units, commonly referred to as a parallel processing environment. The computer system 700 may be a conventional computer, a distributed computer, or any other type of computer, such as one or more external computers made available via a cloud computing architecture. The presently described technology is optionally implemented in software devices loaded in memory 708, stored on a configured DVD/CD-ROM 710 or storage unit 712, and/or communicated via a wired or wireless network link 714 on a carrier signal, thereby transforming the computer system 700 in FIG. 22 to a special purpose machine for implementing the described operations.

The I/O section 704 is connected to one or more user-interface devices (e.g., a keyboard 716 and a display unit 718), a disc storage unit 712, and a disc drive unit 720. Generally, the disc drive unit 720 is a DVD/CD-ROM drive unit capable of reading the DVD/CD-ROM medium 710, which typically contains programs and data 722. Computer program products containing mechanisms to effectuate the systems and methods in accordance with the presently described technology may reside in the memory section 704, on a disc storage unit 712, on the DVD/CD-ROM medium 710 of the computer system 700, or on external storage devices made available via a cloud computing architecture with such computer program products, including one or more database management products, web server products, application server products, and/or other additional software components. Alternatively, a disc drive unit 720 may be replaced or supplemented by a floppy drive unit, a tape drive unit, or other storage medium drive unit. The network adapter 724 is capable of connecting the computer system 700 to a network via the network link 714, through which the computer system can receive instructions and data embodied in a carrier wave. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 700 is connected (by wired connection or wirelessly) to a local network through the network interface or adapter 724, which is one type of communications device. When used in a WAN-networking environment, the computer system 700 typically includes a modem, a network adapter, or any other type of communications device for establishing communications over the wide area network. In a networked environment, program modules depicted relative to the computer system 700 or portions thereof, may be stored in a remote memory storage device. It is appreciated that the network connections shown are examples of communications devices for and other means of establishing a communications link between the computers may be used.

In an example implementation, the computer system 700 may include the controller 102, the analytics system 108, and/or other computing devices described herein. A plurality of internal and external databases, source databases, and/or data cache on the servers are stored as the memory 708 or other storage systems, such as the disk storage unit 712 or the DVD/CD-ROM medium 710, and/or other external storage devices made available and accessible via a cloud computing architecture. Patient management software and other modules and services may be embodied by instructions stored on such storage systems and executed by the processor 702. Some or all of the operations described herein may be performed by the processor 702. Further, local computing systems, remote data sources and/or services, and other associated logic represent firmware, hardware, and/or software configured to perform some or all of the operations described herein. Such services may be implemented using a general purpose computer and specialized software (such as a server executing service software), a special purpose computing system and specialized software (such as a mobile device or network appliance executing service software), or other computing configurations. In addition, one or more functionalities of the systems and methods disclosed herein may be generated by the processor 702 and a user may interact with a Graphical User Interface (GUI) using one or more user-interface devices (e.g., the keyboard 716, the display unit 718, and the user devices 704) with some of the data in use directly coming from online sources and data stores. The system set forth in FIGS. 21 and 22 are but one possible example of a network environment and computer system, respectively, that may employ or be configured in accordance with aspects of the present disclosure.

The operations resulting from the use of the presently disclosed technology may be referred to as Echocardiography-Guided Anesthesia Management (EGAM) and/or Echocardiography-Guided Hemodynamic Management (EGHEM). EGAM/EGHEM may automatically acquire ultrasound-generated real-time data points like cardiac output and filling pressures to assess, manage, modify and optimize the patient cardiac preload, afterload, heart rate and contractility.

While the term provider has been used throughout the present disclosure, it is to be understood that this is not limited to a licensed medical doctor, physician assistant, nurse practitioner, and the like. Instead, provider can by any user of the system. Preferably, the provider is someone working under the guidance of a licensed practitioner and who understands cardiovascular function so as to provide suitable input to the system.

Additionally, while the phrase black and white has been used with reference to certain ultra-sound images, it is to be understood that black and white means a non-color image. That is, an image that does not accurately depict the colors of the displayed elements, but rather displays similar but varying tones of several elements to make them distinguishable from one another. For example, black and white, sepia, orange, or green colors may be included within the black and white description.

Additionally, the categories of cardiovascular determinants are not limited to those categories discussed herein. More or less precise categories could be used and the image clip databases and categories can be adjusted accordingly. For example, with respect to contractile function, rather than using hyperdynamic, normal, moderately reduced, and severely reduced as categories, the categories could instead be normal and abnormal. The contractile function image clip database can be adjusted to include normal clips and abnormal clips and to include only two categories in lieu of four. This holds true for all of the image clip databases and the associated categories.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
generating a clinical management strategy based on cardiovascular function status of one or more patients;
receiving clinical intelligence generated based on structured and unstructured data according to an operational mode; and
optimizing the clinical management strategy based on the clinical intelligence using a processor.

2. The method of claim 1, wherein the clinical management strategy includes modification of one or more cardiovascular determinants.

3. The method of claim 1, wherein the cardiovascular function status is determined based on at least one of: a cardiac output status, filling pressure status, systolic blood pressure status, ventricular contractility status, or valvular function status.

4. The method of claim 1, wherein the operational mode is a predictive and prospective dynamic mode.

5. The method of claim 1, wherein the operational mode is a predictive and prospective static mode.

6. The method of claim 1, wherein the operational mode is a retrospective mode.

7. The method of claim 1, wherein the clinical intelligence includes ad-hoc reporting.

8. The method of claim 1, wherein the clinical intelligence includes advanced analytics obtained using machine learning.

9. The method of claim 1, wherein the clinical intelligence includes point-of-care research.

10. The method of claim 1, wherein the structured data includes cardiovascular function information.

11. The method of claim 1, wherein the unstructured data includes care delivery information.

12. One or more tangible computer-readable storage media storing computer-executable instructions for performing a computer process on a computing system, the computer process comprising:
generating a clinical management strategy based on cardiovascular function status of one or more patients;
receiving clinical intelligence generated based on structured and unstructured data according to an operational mode; and
optimizing the clinical management strategy based on the clinical intelligence.

13. A method comprising:
receiving a query relating to clinical patient management;
identifying a subset of structured and unstructured data from one or more storage cluster locations based on a set of connections between one or more relevancy values assigned to the structured and unstructured data, the set of connections corresponding to the query; and
generating clinical intelligence responsive to the query using a processor, the clinical intelligence generated based on the subset of structured and unstructured data.

14. The method of claim 13, wherein the clinical intelligence is prospective dynamic analytics.

15. The method of claim 13, wherein the clinical intelligence is prospective static analytics.

16. The method of claim 13, wherein the clinical intelligence is retrospective analytics.

17. The method of claim 13, wherein the clinical intelligence includes point-of-care research.

18. The method of claim 13, wherein the clinical management strategy is determined based on cardiovascular function status of the one or more patients.

19. The method of claim 13, wherein the query is user input.

20. One or more tangible computer-readable storage media storing computer-executable instructions for performing a computer process on a computing system, the computer process comprising:
receiving a query relating to clinical patient management;
identifying a subset of structured and unstructured data from one or more storage cluster locations based on a set of connections between one or more relevancy values assigned to the structured and unstructured data, the set of connections corresponding to the query; and
generating clinical intelligence responsive to the query based on the subset of structured and unstructured data.

21. A method comprising:
receiving structured and unstructured data corresponding to one or more patients;
assigning one or more relevancy values to the structured and unstructured data using a processor, the relevancy values identifying information contained in the structured and unstructured data; and
storing the structured and unstructured data based on the assigned relevancy values in one or more storage cluster locations.

22. The method of claim 21, wherein the structured data includes cardiovascular function information.

23. The method of claim 21, wherein the unstructured data includes care delivery information.

24. The method of claim 21, wherein the structured and unstructured data includes probe-generated data obtained using one or more probes.

25. The method of claim 24, wherein the probe-generated data includes ultrasound data points and at least one of the one or more probes is an ultrasound probe.

26. The method of claim 21, wherein the one or more relevancy values are assigned a priority.

27. The method of claim 26, wherein relevancy values corresponding to first order data points are assigned a higher priority than relevancy values corresponding to other data points.

28. The method of claim 27, wherein the first order data points include at least one of: cardiac output, filling pressure, or systolic blood pressure.

29. The method of claim 26, wherein the relevancy values corresponding to second order data points are assigned a higher priority than relevancy values corresponding to other data points.

30. The method of claim 29, wherein the second order data points include at least one of: ventricular contractility, valvular function, or pulmonary artery pressure.

31. One or more tangible computer-readable storage media storing computer-executable instructions for performing a computer process on a computing system, the computer process comprising:
receiving structured and unstructured data corresponding to one or more patients;
assigning one or more relevancy values to the structured and unstructured data, the relevancy values identifying information contained in the structured and unstructured data; and
storing the structured and unstructured data based on the assigned relevancy values in one or more storage cluster locations.

32. A method comprising:
generating a clinical management strategy based on a clinical parameter status of one or more patients;
receiving clinical intelligence generated based on structured and unstructured data according to an operational mode; and
optimizing the clinical management strategy based on the clinical intelligence using a processor.

33. The method of claim 32, wherein the clinical parameter status is a cardiovascular status.
